(19) United States
(12) Patent Application Publication
(10) Pub. No.: US 2025/0091066 A1
(43) Pub. Date: Mar. 20, 2025

(54) A Double Nozzle for Creating A Maximum Suction Pressure

(71) Applicant: ZAMIN RAYANEH ARYA BORNA, Rasht, Guilan (IR)

(72) Inventor: Homayoun Loftazar, Tehran (IR)

(73) Assignee: Zamin Rayaneh Arya Borna, Tehran (IR)

(21) Appl. No.: 18/561,753

(22) PCT Filed: Aug. 8, 2022
(86) PCT No.: PCT/IB2022/057376

§ 371 Date: Nov. 17, 2023

(30) Foreign Application Priority Data
May 31, 2022 (US) 63347038

(51) Int. Cl. B05B 7/04; B01F 25/312

(52) U.S. Cl. CPC B05B 7/04; B01F 25/31241

(57) ABSTRACT

A double nozzle to provide a maximum suction pressure and return an injectable fluid to a central point of a current fluid flow is developed. The double nozzle comprise at least three main parts including at least three way intersections tube, a suction tube and a suction chamber that the suction tube and the suction chamber is mounted within the three way intersections tube. The injectable fluid entered to the double nozzle utilizing the suction tube and mixed with the current fluid at a mixing area provided between the suction tube and the suction chamber inside the double nozzle under the provided maximum suction pressure.

The present disclosure application claims priority from pending U.S. Provisional Patent Application Ser. No. 63/374,038, filed on May 31, 2022, entitled “A DOUBLE NOZZLE FOR PROVIDING A MAXIMUM SUCTION PRESSURE”, and priority to pending Iran Patent Application No. 1401501400030035511, filed on 3 Aug. 2022, entitled “A DOUBLE NOZZLE FOR CREATING A SUCTION FLOW TO MIX AT LEAST TWO FLOWS” which is incorporated by reference herein in its entirety.

### TECHNICAL FIELD

The disclosure related to develop a double nozzle for providing a maximum suction pressure in a center point of a current fluid that allow an injectable fluid inject into the current fluid and mixed with the current fluid. The developed double nozzle applied for transferring at least one fluid and/or mixing at least two fluids in a high yield and a shortest length of the double nozzle.

### BACKGROUND ART

These days, the mechanism of popular systems for measuring flow rate as well as mixing fluids is based on a theory and function of venturi meters and venturi tubes. Then, this type of mechanism is used in a wide range of industrial tools and products.

A mechanism of a venturi tube for measuring a flow rate and/or mixing of at least two fluids under a condition of different velocities may cause the creation of a relative suction pressure between a pressure of a smaller cross-sectional portion of the venturi tube and a pressure of a larger cross-sectional portion of the venturi tube, resulting in an entrance of an injectable fluid and mixing of the injectable fluid with a current fluid. However, in the venturi tube, an injection position of the injectable fluid into the current fluid is practically designed as an outer point at the smaller cross-sectional portion.

Although, if a purpose of the venturi tube application is to create a maximum suction pressure resulting from a velocity profile of the current fluid, the maximum suction pressure can be provided in a current fluid's center. For achieving this purpose, the current and injectable fluids must be mixed in an opposite mechanism of the venturi tube, so the maximum suction pressure can be achieved.

Therefore, development of a cost-effective double nozzle for providing the maximum suction pressure in an opposite way of the venturi tube for mixing and transferring fluids is required. Developing the said double nozzle may have some advantages such as creating a central maximum suction pressure as well as increasing mixing efficiency of the injectable fluid into the current fluid in a smaller length of the current fluid.

### SUMMARY OF INVENTION

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In a general aspect, the present disclosure is directed to an exemplary double nozzle to provide a maximum suction pressure. The exemplary double nozzle may comprise a first portion comprising at least three way intersections, a second portion for injecting an injectable fluid inside the first portion of the double nozzle, and a third portion for transferring a mixed fluid, such that the injectable fluid may be mixed to a current fluid in a central point of a current fluid flow under the provided maximum suction pressure.

The above general aspect may have one or more of the following features. In an exemplary implementation, the second portion may comprise a first section and a second section such that an outer diameter of the first section may be larger than an outer diameter of the second section. In an exemplary implementation, an inner diameter of the first section of the second portion may be equal or larger than the second section of the second portion. In an exemplary implementation, the second portion of the double nozzle may further comprise a third section so that the third section may be configured to adjust the second section of the second portion in an appropriate position inside the first portion of the double nozzle. In an exemplary implementation, a first way intersection of the at least three way intersections may be configured to introduce the current fluid into the double nozzle. In an exemplary implementation, the second portion of the double nozzle may be mounted within a second way intersection of the at least three way intersections. In an exemplary implementation, the third portion of the double nozzle may be fixed into a third way intersection of the at least three way intersections. In an exemplary implementation, the third portion may further comprise a first section, a middle section, and a second section. In this exemplary implementation, the first section may be positioned nearby or inside the second section of the second portion of the double nozzle to provide a mixing area and configured to entrance the mixed fluid into the middle section and the second section of the third portion. In an exemplary implementation, a surface area design of the first section of the third portion is different from a surface area design of the second section of the third portion.

In another general aspect, the present disclosure is directed to an exemplary plumbing system for providing a maximum suction pressure to return an injectable fluid to a current flow. The exemplary plumbing system may comprise at least one double nozzle that may comprise at least three way intersections tube, a suction tube, and a suction chamber such that the suction tube may be mounted within a first way intersection of the at least three way intersections tube and the suction chamber may be mounted within the second way intersection of the at least three way intersections tube, at least one flow conduit that may be configured to conduct the higher pressure flow into the double nozzle through a third way intersection of the at least three way intersections tube. Moreover, the exemplary plumbing system may further comprise at least one container containing an injectable fluid that may comprise at least one main body and at least one injectable fluid conduit and at least one mixed fluid conduit. The injectable fluid conduit may be configured to conduct the injectable fluid into the suction tube of the double nozzle and the mixed fluid conduit may be configured to conduct a mixed fluid from the suction chamber of the double nozzle into at least one sanitary device. Additionally, the injectable fluid may inject into the double nozzle due to the maximum suction pressure provided by the suction tube of the double nozzle and mixed at a central point of the higher pressure flow to obtain the mixed fluid and the mixed fluid transferred into the suction chamber.

The above general aspect may have one or more of the following features. In an exemplary implementation, the plumbing may further comprise a non-return valve so that may be positioned between the container and the suction tube of the double nozzle to prevent return back the injecting fluid to the container. In an exemplary implementation, the suction tube of the double nozzle may comprise a first portion and a second portion such that an outer diameter of the first portion may be larger than an outer diameter of the second portion. In this exemplary implementation, the first portion of the suction tube may be positioned inside the first way intersection of the at least three way intersections tube of the double nozzle. In an exemplary implementation, an inner diameter of the first portion may be equal or smaller than an inner diameter of the second portion. In an exemplary implementation, the suction tube may further comprise a third portion that may be mounted around a peripheral area of the second portion of the suction tube. The third portion may be configured to adjust an appropriate position of the first portion of the suction tube inside the double nozzle for creating a maximum suction pressure. In an exemplary implementation, the suction tube may further comprise a fourth portion such that the fourth portion may be connected to the second portion of the suction tube. The fourth portion may comprise a first part with a simple circular shape, a convergence conic circular shape, or a divergence conic circular shape and a taper part. In some exemplary implementation, a taper convergence angle of the fourth portion is in a range of 0 to 180 degree in accordance with a longitudinal axis of the suction tube. In an exemplary implementation, the suction chamber may comprise a first section, a middle section, and a second section. The second section of the suction chamber may be positioned nearby or may be encompassed the first portion of the suction tube to provide a mixing area. In an exemplary implementation, the first section of the suction chamber may have a different surface area design compared to the second section of the suction chamber. In some exemplary implementation, a temperature of the injecting fluid may be less than a temperature of the current flow. In some exemplary implementation, a pressure of the current flow is more than a temperature of the injectable fluid. In an exemplary implementation, the injectable fluid and the current flow have a same pressure and same temperature, a same pressure and a different temperature, a different pressure and a same temperature, or different pressure and different temperature.

### ADVANTAGEOUS EFFECTS OF INVENTION

A double nozzle according to one or more exemplary embodiments of the present disclosure may have the following advantages:
creating a continuous suction pressure for mixing an injectable fluid into a current fluid;
regulating an amount of the suction pressure in accordance with a need of different industrial applications as well as different flows;
creating a maximum suction pressure for injection and mixing of the injectable fluid into a central point of the current fluid and as a result better mixing of the injectable and current fluids;
ability to be used in a vertical axis in different fluid transfer systems;
providing a favorable condition for mixing at least two fluids with different temperatures and reaching a suitable temperature balance in a shortest mixing path of the double nozzle; and
improving an efficiency of the consumption of fluids in various industries, including the consumption of water, and as a result, improving an efficiency of the consumption of a fuel and reduction of a gray wastewater.

### BRIEF DESCRIPTION OF DRAWINGS

The drawing figures depict one or more implementations in accordance with the present teachings, by way of example only, not by way of limitation. In the figures, like reference numerals refer to the same or similar elements.

FIG. 1A illustrates an isometric view of an exemplary double nozzle for providing a maximum suction pressure, consistent with one or more exemplary embodiments of the present disclosure.

FIG. 1B illustrates a cross-sectional view of an exemplary double nozzle for providing a maximum suction pressure, consistent with one or more exemplary embodiments of the present disclosure.

FIG. 2 illustrates an isometric view of an exemplary suction tube of an exemplary double nozzle for injecting an injectable fluid into the exemplary double nozzle, consistent with one or more exemplary embodiments of the present disclosure.

FIG. 3 illustrates an isometric view of an exemplary suction chamber of an exemplary double nozzle for obtaining a mixed fluid and transferring the mixed fluid, consistent with one or more exemplary embodiments of the present disclosure.

FIG. 4 illustrates an isometric view of an exemplary plumbing system for returning a stored water to a water flow of a dishwasher sink faucet utilizing an exemplary double nozzle, consistent with one or more exemplary embodiments of the present disclosure.

FIG. 5 illustrates an isometric view of an exemplary discharge fluid system utilizing an exemplary double nozzle, consistent with one or more exemplary embodiments of the present disclosure.

FIG. 6 illustrates an isometric view of an exemplary aeration system utilizing an exemplary double nozzle, consistent with one or more exemplary embodiments of the present disclosure.

FIG. 7 illustrates an isometric view of an exemplary sandblasting operation utilizing an exemplary double nozzle, consistent with one or more exemplary embodiments of the present disclosure.

### DESCRIPTION OF EMBODIMENTS

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings. The following detailed description is, therefore, not to be taken in a limiting sense, and the scope of the present disclosure is defined only by the appended claims.

The following detailed description is presented to enable a person skilled in the art to make and use the methods and apparatuses disclosed in exemplary embodiments of the present disclosure. For purposes of explanation, specific nomenclature is set forth provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

In an exemplary embodiment, an exemplary double nozzle body may be developed to provide a maximum suction pressure for mixing at least two fluid flows and at least one fluid flow and at least one non-fluid flows with a different or same pressure and/or temperature. In an exemplary embodiment, an exemplary double nozzle may have some advantages such as creating a central maximum suction pressure as well as increasing mixing efficiency of the injectable fluid into the current fluid in a smaller length of the current fluid. The created maximum suction pressure may be a uniform suction pressure or a non-uniform suction pressure.

In an exemplary embodiment, an exemplary double nozzle may comprise at least three main parts. In an exemplary embodiment, the at least three main parts of an exemplary double nozzle may comprise a first portion comprising at least three way intersections, a second portion configured to inject an injectable fluid into an exemplary double nozzle, and a third portion configured to provide a mixing area and introduce a mixed fluid to a place of consumption. In an exemplary embodiment, a current fluid may entrance into an exemplary double nozzle through a first way intersection of the three way intersections of the first portion as well as the suction tube and the suction chamber may be mounted in a second way intersection and a third way intersection of the three way intersections of the first, respectively.

In an exemplary embodiment, an exemplary double nozzle may have a potential application in different industries to transfer or mix the fluids at a high efficiency, for example, but not limited to, water supply systems, water and sewage industries like wastewater treatment plants, sewer systems, sewage treatment facilities, sandblasting services industry, aquaculture industries, cement shotcrete in civil operation, fire extinguisher, or water fountain and fire.

In some exemplary embodiment, an exemplary double nozzle may be configured to recirculate of a fluid loss into a current fluid system. In some exemplary embodiment, the fluid loss may comprise for example, but not limited to, water, a stored water, the water left overnight or for a long period of time in an open container, a effluent of a water purifier and the current fluid system may comprise a home water supply system or a sanitary water supply system for example, but not limited to, a bathroom water supply system such as bathtub faucets and/or bathroom showers, and/or a toilet water supply system such as toilet water tanks, toilet washbasin faucets, and/or toilet water hoses, or any other type of the bathroom water supply system or toilet water supply system that are well known for those skilled in the art.

As used herein, the term “home” refers to a place that a user may live or work.

In an exemplary embodiment, an exemplary double nozzle may be configured to drive out a liquid, for example, but not limited to, water, petrol, gasoline, etc. In this exemplary embodiment, the exemplary double nozzle may be applied as a fluid discharge pump.

In another general exemplary embodiment, a plumbing system may be developed to return an injectable fluid to a higher pressure flow through a provided maximum suction pressure utilizing an exemplary double nozzle.

In an exemplary embodiment, an exemplary plumbing system may comprise at least one exemplary double nozzle, at least one flow conduit, at least one container to maintain an injectable fluid, at least one mixed fluid conduit, and at least one sanitary device.

### A Double Nozzle for Providing a Maximum Suction Pressure

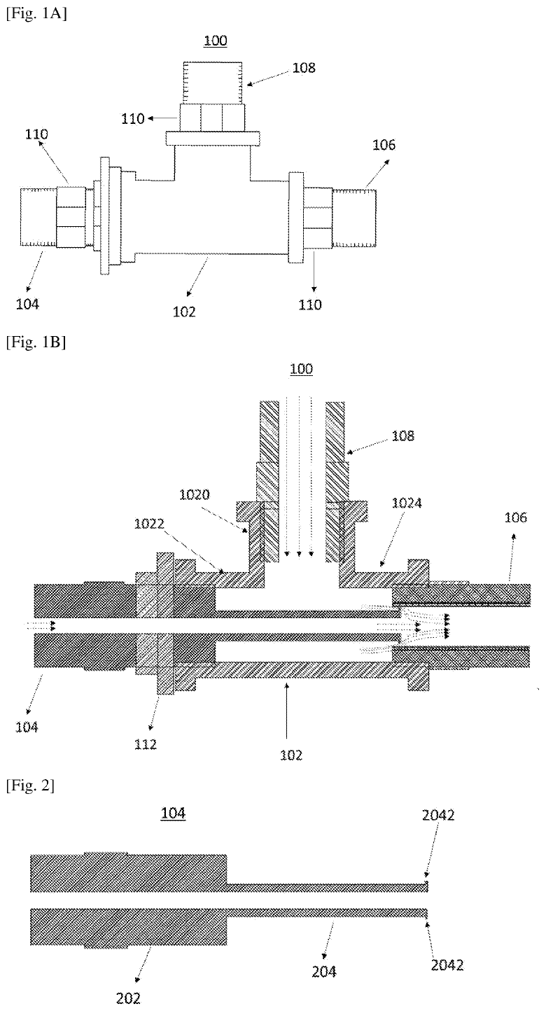

In an exemplary embodiment, a double nozzle may be developed to create a maximum suction pressure due a specific structure and design of the double nozzle that may help to inject an injectable fluid into a current fluid.

[FIG. 1A] and [FIG. 1B], respectively, illustrate an isometric view and a cross-sectional view of an exemplary double nozzle 100 for providing a maximum suction pressure, consistent with one or more exemplary embodiments of the present disclosure. In an exemplary embodiment, as illustrated in [FIG. 1A] and [FIG. 1B], the exemplary double nozzle 100 may comprise at least three way intersections tube 102, a suction tube 104, and a suction chamber 106. In an exemplary embodiment, a current fluid conduit 108 may be mounted within a first way intersection 1020 of the at least three way intersections tube and the first way intersection 1020 of the at least three way intersections tube may be configured to entrance a current fluid (dash arrows, [FIG. 1B]) into the double nozzle 100. In an exemplary embodiment, a second way intersection 1022 of the at least three way intersections tube may be configured to maintain the suction tube 104 and the suction chamber may be mounted within a third way intersection 1024 of the at least three way intersections tube. In an exemplary embodiment, at least three nuts 110 may be configured to fix the current fluid conduit 108, the suction tube 104, and the suction chamber 106 on the double nozzle 100.

[FIG. 2] illustrates an exemplary suction tube 104 of the exemplary double nozzle 100, consistent with one or more exemplary embodiments of the present disclosure. In an exemplary embodiment, the suction tube may be configured to introduce an injectable fluid (dash-dot arrows, [FIG. 1B]) into the double nozzle 100 due to a provided suction pressure as well as inject into a central point of the current fluid ([FIG. 1B]), so that a mixed fluid obtained.

In an exemplary embodiment, as illustrated in [FIG. 2], the exemplary suction tube 104 may comprise a first section 202 and a second section 204 where by an outer diameter of the first section may be larger than an outer diameter of the second section. In an exemplary embodiment, the first section may have an inner diameter equal or larger than the second section. In an exemplary embodiment, the second section 204 may have a narrow blade edge shape 2042 at an end length of the second section of the suction tube. In an exemplary embodiment, the suction tube 104 may further comprise a third section 112 ([FIG. 1B]) that may be configured to adjust a proper position of the suction tube 104, especially the second section of the suction tube 204 inside the double nozzle 100 and may cause providing a mixing area between the second section of the suction tube 204 and the suction chamber 106. Adjusting the proper position of the suction tube inside the double nozzle may affect a suction pressure level. The proper position may be determined in accordance with converging vector components of the current fluid as well as a flow rate of the current fluid. When the proper position is determined for example, but not limited to, utilizing a suction manometer, the suction tube 104 may be positioned in the proper position inside the double nozzle 100 utilizing the third section of the suction tube 112, in that case, a maximum suction pressure may be provided due to a velocity vector of the current fluid and cause a maximum injection velocity of the injectable fluid into the current fluid at the mixing area.

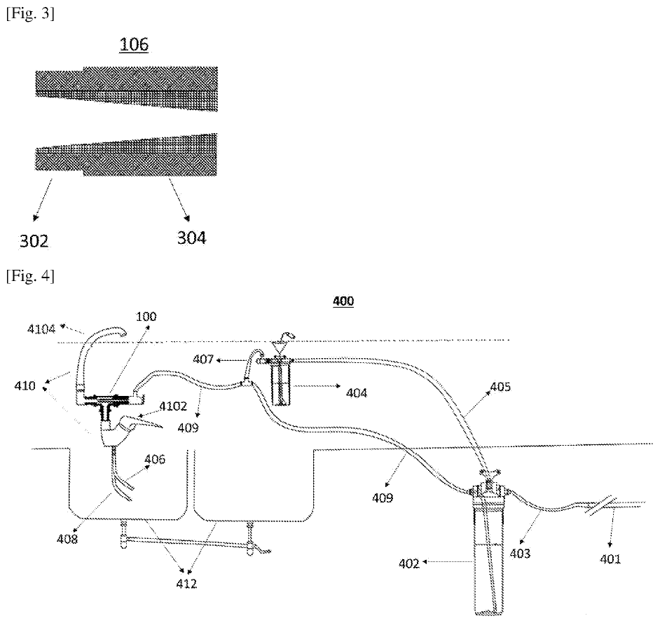

In another exemplary embodiment, the suction tube 104 may further comprise a fourth section (not shown) that may be connected to the second section of the suction tube 204. In an exemplary embodiment, the fourth section may have a specific geometric shape, for example, but not limited to, a simple circular shape, a convergence conic circular shape, a divergence conic circular shape, a narrow blade edge shape, and/or a taper shape. In an exemplary embodiment, a convergence angle of the taper shape may be in a range of 0 to 180 degree in accordance with a longitudinal axis of the suction tube.

[FIG. 3] illustrates an exemplary suction chamber 106 of an exemplary double nozzle, consistent with one or more exemplary embodiments of the present disclosure. In an exemplary embodiment the exemplary suction chamber 106 may comprise a first portion 302 and a second portion 304 such that the first portion may be mounted within the third way intersection of the at least way intersections tube 1024 and configured to provide mixing area for mixing the current fluid and the injectable fluid as well as the second portion 304 may be configured to transfer and introduce the mixed fluid to an output conduit or a final destination or a place of consumption. In an exemplary embodiment, the suction chamber 106 may have a uniform inner diameter. In another exemplary embodiment, an inner diameter of the suction chamber 106 may have a convergence conic circular shape or a divergence conic circular shape.

In some exemplary embodiments, the inner diameter of the suction chamber may differ along a direction of passing the mixed fluids and/or the even at the mixing area. In an exemplary embodiment, an inner diameter of an input of the suction chamber may be larger than inner diameter of an output of the suction chamber. In some exemplary embodiments, the inner diameter of the input of the suction chamber along a longitudinal axis of the suction chamber may be decrease with a defined slope till to the output of the suction chamber.

In another exemplary embodiment, an exemplary suction chamber may comprise at least three parts comprising a first section, a middle section, and a second section. In an exemplary embodiment, the second section of the suction tube 204 may be positioned within the first section of the suction chamber somehow the mixing area may be obtained for mixing the current fluid and the injectable fluid, therefore the mixed fluid may be introduced to the middle section as well as the second section of the suction chamber. In an exemplary embodiment, the second section of the suction chamber may be configured to connect to a conduit that introduce the mixed fluid to an applicable device, for example, but not limited to, a sanitary device such as a flash tank, a toilet faucet, a dishwasher faucet positioned in a dishwasher sink, a bathroom faucet, etc. In an exemplary embodiment, a surface area of the first section of the suction chamber may have a different design compared to a surface area of the second section of the suction chamber. In an exemplary embodiment, the surface area of the first section may be larger than the surface area of the second section of the suction chamber such that when the second section of the suction tube 204 positioned within the first section of the suction chamber, a maximum suction pressure may be provided to a better mixing of the current fluid and the injectable fluid.

In an exemplary embodiment, the fourth section (not shown) of the suction tube may be positioned within the first section of the suction chamber or may be mounted nearby the first section of the suction chamber for providing the maximum suction pressure as well as the mixing area.

In another exemplary embodiment, when it's necessary a direction of the current fluid must be as same as a direction of the mixed fluids in an output of the double nozzle 100, the current fluid conduit 110 may be mounted in the second way intersection 1022 of the at least three intercession-ways tube and the suction tube 104 may be fixed within the first way intersection of the three way intersections tube 1020.

In an exemplary embodiment, the exemplary double nozzle 100 may be applied in different industries, for example, but not limited to, water supply systems, water and sewage industries like wastewater treatment plants, sewer systems, sewage treatment facilities, sandblasting services industry, cement shotcrete in civil operation, fire extinguisher, or water fountain and fire.

In an exemplary embodiment, the exemplary double nozzle 100 may be further applied as a fluid discharge pump for extracting a fluid, for example, but not limited to, water, petrol, gasoline, etc.

In an exemplary embodiment, the current fluid and the injectable fluid may comprise two same or different liquids, a liquid and a solid, a liquid and a gas, a solid and a liquid, a solid and a gas, a gas and a liquid, two same or different gases, or a gas and a solid.

In an exemplary embodiment, the current fluid and the injectable fluid may have a same pressure and a same temperature, a same pressure and a different temperature, a different pressure and a same pressure, and a different pressure and a different temperature.

### A Plumbing System for Returning an Injectable Fluid to a Higher Pressure Flow Utilizing a Double Nozzle

Effective variables in the generating thermal shocks are a function of a plurality of internal factors for example, but not limited to, dimensional characteristics and type of piping system, location, arrangement and efficiency of a heating system relative to the hot water consumption location, as well as a plurality of external factors for example, but not limited to, a geographical location, a seasonal usage, and as a result, the cold water temperature conditions entering the heating system of the building are desired. So that, the effective variables in creating the thermal shocks of water consumption may include volume-dependent variables, such as the a length and diameter of the hot water piping path from a location of the heating system to a place of water consumption and a temperature and pressure of inlet water as well as a time of heat exchange between an incoming cold water and a heating value resulting from a heat exchanger of the heating system, in other words, is a heat efficiency of the heating system.

Accordingly, the cause of fluid losses due to the thermal shocks in domestic use can be classified into two separate groups of losses including a static losses and a dynamic losses. In an exemplary embodiment, the static losses may refer to a volume of a cold static fluid stored along a hot fluid conduit before open a sanitary device to introduce the fluid into a place of consumption and turning on the heating system. In an exemplary embodiment, the dynamic losses may refer to a volume of the fluid flowing from a hot fluid conduit through the sanitary device and caused turning on the heating system to provide a desire hot fluid reaches to the place of consumption. In a common condition, the volume of the static losses and dynamic losses may become inaccessible over time and turn into a gray effluent.

Furthermore, there may be other losses in the domestic use that can recirculate into the current fluid resulted in a better current fluid consumption as well as a better consumption management. It has many benefits and also can affect the energy consumption in both domestic and industrial uses.

So, in an exemplary embodiment, a plumbing system may be developed to retune the fluid losses into a current fluid, utilizing an exemplary double nozzle that is disclosed in one or more exemplary embodiments of the present disclosure.

In an exemplary embodiment the current fluid may have a higher pressure and/or a higher temperature compared to the injectable fluid. In an exemplary embodiment, the current fluid and the injectable fluid may have a same pressure and/or a same temperature.

In an exemplary embodiment, the plumbing system may comprise at least one double nozzle, at least one flow conduit, at least one container containing an injectable fluid, at least one mixed fluid conduit, and at least one sanitary device.

In an exemplary embodiment, the container containing the injectable fluid may comprise a main body and at least one injectable fluid conduit. In an exemplary embodiment, the main body of the container may be under a pressure in a range of an environment pressure to a pressure as same as the current fluid. In an exemplary embodiment, the container may be under a pressure in a range of a minimum pressure of the current fluid and a maximum pressure of the current fluid and may be made of a material that can tolerate the pressure to maintain the injectable fluid as well as to transfer the injectable fluid into the current fluid.

In an exemplary embodiment, the injectable fluid may be introduce into the exemplary suction tube 104 of the double nozzle by passing through the injectable fluid conduit and mixed at a central point of the current fluid flow and then a mixed fluid may introduce into the mixed fluid conduit through passing the exemplary suction chamber 106 of the double nozzle to reach the sanitary device as well as the place of consumption.

In an exemplary embodiment, the injectable fluid may comprise all kinds of the fluid losses comprising the static loss, the dynamic loss, a stored fluid and/or a fluid left overnight or for a long time in a container, and/or an effluent of a purifier device like a water purifier.

In an exemplary embodiment, the plumbing system may further comprise a non-return valve that the non-return valve may be positioned between the container and the exemplary suction tube 104 of the double nozzle configured to prevent return back the injectable fluid to the container.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed.

### EXAMPLES

### Example 1: A Plumbing System for Returning a Stored Water to a Water Flow of a Dishwasher Sink Faucet Utilizing a Double Nozzle

In Example 1, a plumbing system was developed to return a stored water to a water flow of a dishwasher sink faucet utilizing an exemplary double nozzle, consistent with the teachings of the exemplary embodiments of the present disclosure. In this example, as illustrated in [FIG. 4], the plumbing system 400 may comprise an exemplary double nozzle 100, a first non-pressurized container 402, a second non-pressurized container 404, a cold and a hot water piping 406,408, at least one faucet 410, at least one double dishwasher sink 412. Furthermore, the plumbing system may further comprise a first, second, third, and fourth connecting conduits 403,405,407,409 that the each of these connecting conduits may configured to transfer the stored water or an extra water to different parts of the plumbing system. The first container 402 may configured to store the extra water and/or an effluent that may be produced from an applicable device at home such as a water purifier device that the extra or effluent may automatically introduce to the first container 402 through passing the first and the second connecting conduits 401, 405, respectively. A first end of the first conduit may be connected to the applicable device and the second end of the first conduit may be connected to a first end of the second conduit as well as a second end of the second conduit may be connected to the first container 402. When a user open the faucet 410 utilizing a faucet lever 4012, the water flow from either the cold piping 406 or the hot water piping 408 initially introduce to the double nozzle 100 via the first way intersection 1020, so due to entrance of the water flow into the exemplary double nozzle 100, a suction pressure is created that cause the stored water inside the first container pull into the exemplary suction tube 104 of the double nozzle and inject into the water flow as the current flow. Then, the mixed flow of the water flow and the stored water is obtained at the mixing area and is introduced to the dishwasher sink 412 by passing the exemplary suction chamber 106 and a faucet spout 4104, respectively. If a capacity of the first container 402 full filled, the extra water can be introduced to the second container 404 by passing the second conduit 405. The second container can be connected to the fourth conduit 409 utilizing the third conduit 407 and when the user opens the faucet lever 4102, the stored water in the second container 404 can be used as the injectable fluid and introduced to the water flow. The second container may be placed at a same level as the dishwasher faucet 410 to allow the stored water to be transferred from the second container 404 to the exemplary double nozzle 100. On the other hand, the first container 402 can be connected indirectly to the water waste of the dishwasher sink (not illustrated) to prevent overflowing of the stored water. An overflowing connection path (not shown) may be installed from an excess way from the second container 404 into an upper segment (not shown) of the dishwasher sink 412.

### Example 2: A Discharge Fluid System Utlizing a Double Nozzle

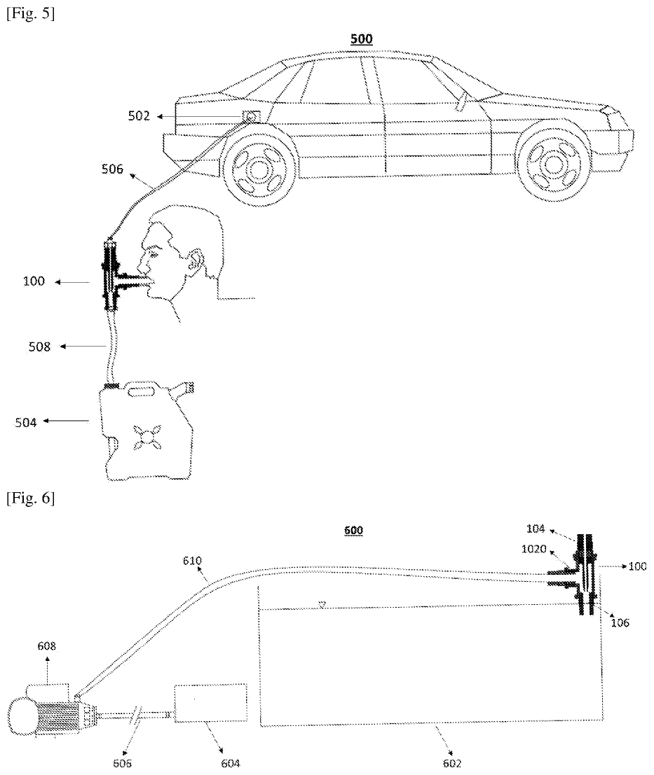

In Example 2, a discharge fluid system was carried out to drive out a gasoline from a car tank to a container utilizing an exemplary double nozzle, consistent with the teachings of the exemplary embodiments of the present disclosure. In this example, as illustrated in [FIG. 5], in the discharge fluid system 500, an air flow, for example, but not limited to, a human exhalation, from the exemplary current flow conduit 108 enters the exemplary double nozzle 100 by passing through the exemplary first way intersection, when the air flow enters the exemplary double nozzle 100, a positive pressure as a suction pressure is created that causes the gasoline from a car tank 502 discharge out. Then, the gasoline enters the exemplary double nozzle 100 via the exemplary suction tube 104 by passing a first pipe 506 that is connected to the car tank 502 as well as the exemplary suction tube 104. After that, the gasoline is introduced to a container 504 by passing the exemplary suction chamber 106 of the double nozzle as well as a second pipe 508.

In such applications, in contrast with a typical pump, by using a positive pressure a fluid can be driven out from a first destination to a second destination due to a specific design of the exemplary double nozzle 100.

### Example 3: An Aeration System Utilizing a Double Nozzle

Aeration is a mechanical method to dissolve the air in the water. This is achieved by increasing the contact surface between the water and air. There are various factors that impact of the aeration process including a type and properties of a material, an environmental temperature, resistance to mass transfer, partial pressure of a gas, an environmental turbulence, a ratio of surface to volume (when the surface to volume ratio is higher a better aeration efficiency is achieved), and a contacting time.

Aeration may applied in many industries such as the water treatment industry and sewage treatment systems and/or the aquaculture industries for removing unwanted substances like CO₂, CH₄, H₂S, volatile substances, and radon by contacting these substances with the oxygen and turning them to the useful substances; removing the odor and taste factors (the cause of the odor in water is dissolution of some gases in the water and the cause of the taste is dissolution of some ions in the water, so with aeration, the mentioned materials react with oxygen and removed from the water), and oxidation of iron and manganese.

In Example 3, the aeration process was carried out utilizing an exemplary double nozzle, consistent with the teachings of the exemplary embodiments of the present disclosure. In this example, as illustrated in [FIG. 6], in the aeration process 600, for injecting the air into a water pool 602 (both in the water treatment industry and in the aquaculture industry), a predetermined amount of water from a water container 604 was passed through a first pipe 606 into a water pump 608. Then, the water pump 608 was introduced the water through a second pipe 610, which is connected to the first way intersection of the three way intersections tube 1020, into the double nozzle 100 as the current fluid as well as the air may enter to the double nozzle 100 through the suction tube 104 as the injectable fluid. Following that, the air and the water was mixed at the mixing area and introduced to the water pool 602 by passing through the suction chamber 106.

Also, the water container 604 can be eliminated and aeration process can be carried out in a closed system. In this case, the first pipe 606 is connected to the water pool 602 instead of the water container 602.

### Example 4: A Sandblasting Operation Utlizing a Double Nozzle

In a sandblasting operation, a problem of wear inside an abrasive jet is due to a use of a jet of pressure air or a compressed water as a current fluid in addition to a specific approach angle of adding the solid materials (sand or other solid particles) that cause an uncoordinated discharge of the solid materials compared to a velocity profile of the current fluid. In practice, the solid materials are in more and non-uniform contact with the cross-section of the abrasive jet and this phenomena causes additional and unwanted costs during the sandblasting operation. Furthermore, the abrasive jet is sometimes blocked due to waste and dirty materials or the grains of the solid materials that are larger than a standard size.

In order to solve the related technical and financial problems mentioned above, it is very important and fundamental to know the mechanisms of the abrasive jet. Generally, a pressure of the solid materials such as sand, is far less than a pressure of the air or water in the sandblasting operation, and despite an abrasion caused by the solid materials; the sandblasting is done by a higher pressure that created by the jet air or water. In the sandblasting operation, the mixing of the solid materials and the air or water takes place in an uncontrolled manner so it leads to wear the abrasive jet. Therefore, there is a need to create a mixing in a controlled manner such that a higher density of the solid materials is in a center of the mixed fluid and the water or air creates a shell in an outer layer of the mixed fluid to cover the solid materials. So that the protection of the abrasive jet from wear as well as preventing blocking of the abrasive jet is provided. The said mixing can be provided utilizing a double nozzle in accordance with one or more exemplary embodiments of the present disclosure.

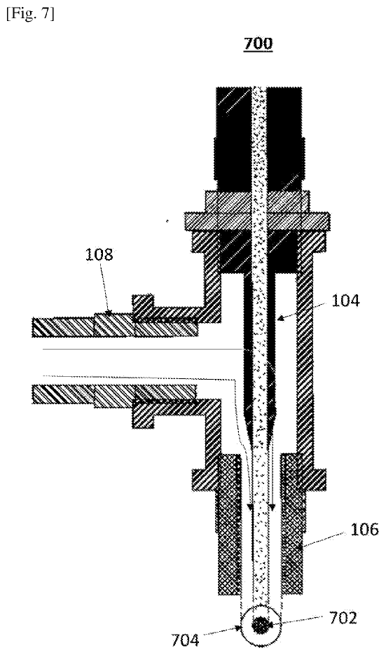

In Example 4, a sandblasting operation was carried out utilizing an exemplary double nozzle, consistent with the teachings of the exemplary embodiments of the present disclosure. In this example, as illustrated in [FIG. 7], in the sandblasting operation 700, the solid materials enter the exemplary double nozzle 100 as the injectable fluid through the exemplary suction tube 104, and on the other hand, a pressurized water or air enters the double nozzle 100 as the current fluid through the current fluid conduit 108 such that the solid materials inject into a central point of the pressurized water of air flow. Following that, a solid materials-water/air flow is provided and this flow is directed out of the double nozzle 100 by passing the exemplary suction chamber 106 of the double nozzle and sprayed on a target area. The mixed flow includes the solid material 702 as a central area of the mixed flow and the pressurized water or air 704 as an outer layer of the mixed flow. As used herein, the term “solid materials” may refer to a well sorted pure sand or a well sorted sand with a metal fiber like copper or silicon carbide or quartz and so on.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood that the terms and expressions used herein have the ordinary meaning as is accorded to such terms and expressions with respect to their corresponding respective areas of inquiry and study except where specific meanings have otherwise been set forth herein. Relational terms such as first, second, and third and the like may be used solely to distinguish one entity or action from another without necessarily requiring or implying any actual such relationship or order between such entities or actions. The terms “comprises,” “comprising,” “include,” “including,” or any other variation thereof, are intended to cover a non-exclusive inclusion, such that a process, method, article, apparatus, or device that comprises a list of elements does not include only those elements but may include other elements not expressly listed or inherent to such process, method, article, apparatus, or device. An element proceeded by “a” or “an” does not, without further constraints, preclude the existence of additional identical elements in the process, method, article, or device that comprises the element. Moreover, “may” and other permissive terms are used herein for describing optional features of various embodiments. These terms likewise describe selectable or configurable features generally, unless the context dictates otherwise.

1. A double nozzle to provide a maximum suction pressure, the double nozzle comprising:
a first portion comprising at least three-way intersections;
a second portion configured to inject an injectable fluid inside the first portion of the double nozzle; and
a third portion configured to transfer a mixed fluid,
wherein the injectable fluid is mixed to a current fluid in a central point of a current fluid flow under the provided maximum suction pressure.

2. The double nozzle according to claim 1, wherein the second portion comprises a first section and a second section wherein an outer diameter of the first section is larger than an outer diameter of the second section.

3. The double nozzle according to claim 2, wherein an inner diameter of the first section of the second portion is equal or larger than the second section of the second portion.

4. The double nozzle according to claim 3, wherein the second portion of the double nozzle further comprises a third section wherein the third section is configured to adjust the second section of the second portion in an appropriate position inside the first portion of the double nozzle.

5. The double nozzle according to claim 1, wherein a first way intersection of the at least three way intersections is configured to introduce the current fluid into the double nozzle.

6. The double nozzle according to claim 1, wherein the second portion of the double nozzle is mounted within a second way intersection of the at least three way intersections.

7. The double nozzle according to claim 1, wherein the third portion of the double nozzle is fixed into a third way intersection of the at least three way intersections.

8. The double nozzle according to claim 1, wherein the third portion further comprises a first section, a middle section, and a second section, wherein the first section is positioned nearby or inside the second section of the second portion of the double nozzle to provide a mixing area and configured to entrance the mixed fluid into the middle section and the second section of the third portion.

9. The double nozzle according to claim 8, wherein a surface area design of the first section of the third portion is different from a surface area design of the second section of the third portion.

10. The double nozzle according to claim 1, wherein the injectable fluid and the current fluid have a same pressure or a different pressure and a same temperature or different temperature.

11. The double nozzle according claim 1, wherein the injectable fluid and the current fluid comprise any kind of liquid, solid, or gas substances.

12. A plumbing system for providing a maximum suction pressure to return an injectable fluid to a current flow, the plumbing system comprising: at least one double nozzle comprising at least three way intersections tube, a suction tube, and a suction chamber, wherein the suction tube is mounted within a first way intersection of the at least three way intersections tube and the suction chamber is mounted within the second way intersection of the at least three way intersections tube;
at least one flow conduit configured to conduct the current flow into the double nozzle through a third way intersection of the at least three way intersections tube;
at least one container containing an injectable fluid comprising at least one main body and at least one injectable fluid conduit configured to conduct the injectable fluid into the suction tube of the double nozzle; and
at least one mixed fluid conduit configured to conduct a mixed fluid from the suction chamber of the double nozzle into at least one sanitary device,
wherein the injectable fluid injects into the double nozzle due to the maximum suction pressure provided by the suction tube of the double nozzle and mixed at a central point of the current flow to obtain the mixed fluid and the mixed fluid transferred into the suction chamber.

13. The plumbing system according to claim 12, further comprising a non-return valve wherein positioned between the container and the suction tube of the double nozzle to prevent return back the injectable fluid to the container

14. The plumbing system according to claim 12, wherein the suction tube of the double nozzle comprises a first portion and a second portion wherein an outer diameter of the first portion is larger than an outer diameter of the second portion and the first portion of the suction tube is positioned inside the first way intersection of the at least three way intersections tube of the double nozzle.

15. The plumbing system according to claim 14, wherein an inner diameter of the first portion is equal or smaller than an inner diameter of the second portion.

16. The plumbing system according to claim 14, the suction tube further comprising a third portion mounted around a peripheral area of the second portion of the suction tube wherein the third portion is configured to adjust an appropriate position of the first portion of the suction tube inside the double nozzle for creating a maximum suction pressure.

17. The plumbing system according to claim 14, the suction tube further comprising a fourth portion wherein the fourth portion is connected to the second portion of the suction tube, wherein the fourth portion has a simple circular shape, a convergence conic circular shape, a divergence conic circular shape, or a narrow blade edge shape.

18. The plumbing system according to claim 17, wherein a taper convergence angle of the fourth portion is in a range of 0 to 180 degree in accordance with a longitudinal axis of the suction tube.

19. The plumbing system according to claim 14, wherein the suction chamber comprises a first section, a middle section, and a second section wherein the second section of the suction chamber is positioned nearby or encompassed the first portion of the suction tube to provide a mixing area.

20. The plumbing system according to claim 19, wherein a surface area design of the first section of the suction chamber is different from a surface area design of the second section of the suction chamber.

21. The plumbing system according to claim 12, wherein a temperature of the injecting fluid is less than a temperature of the current flow.

22. The plumbing system according to claim 12, wherein a pressure of the current flow is more than a temperature of the injectable fluid.

23. The plumbing system according to claim 12, wherein the injectable fluid and the current flow have a same pressure and same temperature, a same pressure and a different temperature, a different pressure and a same temperature, or different pressure and different temperature

24. The double nozzle according to claim 1, wherein an inner diameter of the first section of the second portion is equal or larger than the second section of the second portion and the second portion of the double nozzle further comprises a third section wherein the third section is configured to adjust the second section of the second portion in an appropriate position inside the first portion of the double nozzle.
